(19) United States
(12) Patent Application Publication
(10) Pub. No.: US 2025/0270146 A1
(43) Pub. Date: Aug. 28, 2025

(54) SECONDARY-FOAMED FOAM CONCRETE AND PREPARATION METHOD THEREOF

(71) Applicant: Hebei University of Technology, Beichen District (CN)

(72) Inventors: Boxiong SHEN, Beichen District (CN); Zhibin HAN, Beichen District (CN); Qiwei YANG, Beichen District (CN)

(21) Appl. No.: 18/958,589

(22) Filed: Nov. 25, 2024

(30) Foreign Application Priority Data
Feb. 27, 2024 (CN) 202410211520.0

(51) Int. Cl. C04B 38/02; C04B 14/06; C04B 18/08; C04B 24/08; C04B 24/32; C04B 28/04; C04B 103/00; C04B 103/40

(52) U.S. Cl. CPC C04B 38/025; C04B 14/06; C04B 18/08; C04B 24/085; C04B 24/32; C04B 28/04; C04B 2103/0001; C04B 2103/40

(57) ABSTRACT

Disclosed are a secondary-foamed foam concrete and a preparation method thereof, belonging to the technical field of concretes. Raw materials for preparing the secondary-foamed foam concrete include a main material and an additive. The main material includes an aggregate-mineral admixture, a cement, and water. The additive includes an emulsifier, an aqueous hydrogen peroxide solution, a biomass, and a microorganism, the biomass being an animal liver containing catalase. The aqueous hydrogen peroxide solution in the secondary-foamed foam concrete is compatible with the animal liver containing catalase, and the animal liver containing catalase is compatible with the microorganism, and these materials separately foam upon contact, whereby a foam concrete is foamed twice.

### CROSS-REFERENCE TO RELATED APPLICATION

This patent application claims the benefit and priority of Chinese Patent Application No. 2024102115200, entitled “SECONDARY-FOAMED FOAM CONCRETE AND PREPARATION METHOD THEREOF” filed on Feb. 27, 2024, the disclosure of which is incorporated by reference herein in its entirety as part of the present application.

### TECHNICAL FIELD

The present disclosure belongs to the technical field of concretes, and in particular relates to a secondary-foamed foam concrete and a preparation method thereof.

### BACKGROUND

At present, reducing environmental pollution and building energy conservation have become the mainstream development trend in the construction industry. The construction industry is estimated to be responsible for about 38% of global carbon dioxide emissions due to intensive mining and high embodied energy consumption. With rapid progress in urbanization, energy consumption in the construction industry will continue to increase in the foreseeable future. In this context, building energy conservation and building sustainability have received widespread attention globally with the aim of mitigating global warming emissions. A concrete structure generally has a density of 2360 kg/m³, a heat conductivity coefficient of 0.9-4 W/(m·K), and a relatively small thermal resistance. Conversely, foamed cement, due to its low density of typically 200 to 1600 kg/m³, could for one thing save building materials, and for another, low density could reduce building weight. Further, foamed cement has good heat preservation and insulation performance, and has a heat conductivity coefficient of 0.06-0.28 W/(m·K). Moreover, foamed cement has a sound absorption capacity of about 0.09-0.19% due to high porosity, and has a good sound absorption effect, fireproofing and other superior performance. Such superior performance is very consistent with the requirements of building energy saving, and therefore foamed cement has gradually become a new class of energy-saving wall materials of widespread concern.

However, the problem of short hardening time exists in the current foam concrete, which affects the stability of foaming and likely causes self-weight slump.

### SUMMARY

It is an object of the present disclosure to provide a secondary-foamed foam concrete and a preparation method thereof. The secondary-foamed foam concrete provided by the present disclosure is not adversely affected by cement hardening or self-weight slump, and has the characteristics of reduced heat conductivity coefficient, high porosity, and relatively low production cost, and thus could be massively applied to actual production.

In order to achieve the object described above, the present disclosure provides the following technical solutions.

The present disclosure provides a secondary-foamed foam concrete, where raw materials for preparing the same include a main material and an additive.

The main material includes an aggregate-mineral admixture, a cement, and water; and a mass ratio of the aggregate-mineral admixture, the cement, and the water is in a range of (10-20):(40-60):(20-35).

The additive includes an emulsifier, an aqueous hydrogen peroxide solution, a biomass, and a microorganism, the biomass being an animal liver containing catalase; and the aqueous hydrogen peroxide solution having a hydrogen peroxide mass percentage concentration of 25-30%.

A mass of the emulsifier accounts for 0.5-3.5% of a mass of the main material.

A mass of the aqueous hydrogen peroxide solution accounts for 0.5-2% of the mass of the main material.

A mass of the biomass accounts for 0.4-0.7% of the mass of the main material.

A mass of the microorganism accounts for 0.5-1% of the mass of the main material.

In some embodiments, the microorganism includes at least one selected from the group consisting of lactobacillus, propionic acid-producing bacteria, leuconostoc, and streptococcus.

In some embodiments, the emulsifier includes at least one selected from the group consisting of coconut monoethanol amide, Span 60 (sorbitan monostearate), Span 80 (sorbitan monooleate), Tween 60 (polyoxyethylene sorbitan monostearate), Tween 80 (polyoxyethylene-sorbitan-20 monooleate).

In some embodiments, the cement is ordinary Portland cement 42.5.

In some embodiments, the aggregate in the aggregate-mineral admixture is a fine sand; and a mineral admixture in the aggregate-mineral admixture includes at least one selected from the group consisting of fly ash, a limestone powder, a zeolite powder, blast furnace slag, and a steel slag powder.

The present disclosure provides a method for preparing the secondary-foamed foam concrete described in the technical solutions above, including the following steps:
(1) mixing the cement, the aggregate-mineral admixture, the water, the emulsifier, the aqueous hydrogen peroxide solution, and the biomass, and subjecting a resulting mixture to a first foaming, to obtain a primary-foamed foam concrete; and
(2) mixing the primary-foamed foam concrete and a microorganism, and subjecting a resulting system to a second foaming in a mold, to obtain the secondary-foamed foam concrete.

In some embodiments, the first foaming is performed at room temperature for 20 s to 1 min, and the first foaming is performed under a stirring condition with a stirring rotation speed of 120 r/min.

In some embodiments, the second foaming is performed at room temperature for 6-24 h.

In some embodiments, in step (1), the mixing includes
subjecting the biomass, the water, and the emulsifier to a first mixing, to obtain a biomass emulsion; subjecting the aggregate-mineral admixture, the cement, and the biomass emulsion to a second mixing, to obtain a paste; and mixing the paste and the aqueous hydrogen peroxide solution for the first foaming.

In some embodiments, the second mixing is performed at room temperature for 1 min, and the second mixing is performed by stirring at a rotation speed of 80 r/min.

The present disclosure provides a secondary-foamed foam concrete, where raw materials for preparing the same include a main material and an additive; the main material includes an aggregate-mineral admixture, a cement, and water; and a mass ratio of the aggregate-mineral admixture, the cement, and the water is in a range of (10-20):(40-60):(20-35); the additive includes an emulsifier, an aqueous hydrogen peroxide solution, a biomass, and a microorganism, the biomass being an animal liver containing catalase, and the aqueous hydrogen peroxide solution having a mass percentage content of 25-30%; a mass of the emulsifier accounts for 0.5-3.5% of a mass of the main material; a mass of the aqueous hydrogen peroxide solution accounts for 0.5-2% of the mass of the main material; a mass of the biomass accounts for 0.4-0.7% of the mass of the main material; and a mass of the microorganism accounts for 0.5-1% of the mass of the main material. The aqueous hydrogen peroxide solution in the secondary-foamed foam concrete provided by the present disclosure is compatible with the animal liver containing catalase, and the animal liver containing catalase is compatible with the microorganism, and these materials separately foam upon contact, whereby the foam concrete provided by the present disclosure is foamed twice. In addition, by adding an emulsifier while controlling the mass content of each of the above mentioned raw materials, the concrete system obtained by the present disclosure is closer to an oily system, and typically has a good fluidity, a larger slump degree, and a shorter initial coagulation time, as compared with an aqueous system, which is unfavorable to porosity. The oily system of the present disclosure has a slow hardening speed, has plasticity, is not prone to slump under self-weight, and has a more thorough foaming process, so that the secondary-foamed foam concrete provided by the present disclosure may not be affected by cement hardening or self-weight slump, has the characteristics of reduced heat conductivity coefficient, high porosity, and relatively low production cost, and could be massively applied to actual production.

The present disclosure provides a method for preparing the secondary-foamed foam concrete described in the technical solutions above, the method including the following steps: (A) mixing a cement, an aggregate-mineral admixture, water, an emulsifier, an aqueous hydrogen peroxide solution, and a biomass, and subjecting a resulting mixture to a first foaming to obtain a primary-foamed foam concrete; and (B) mixing the primary-foamed foam concrete and a microorganism, and then subjecting a resulting system to a second foaming in a mold to obtain the secondary-foamed foam concrete. By performing two foaming processes in separate steps, the method provided by the present disclosure is able to ensure that the two foaming processes are more thorough, so that the secondary-foamed foam concrete provided by the present disclosure may not be affected by cement hardening or self-weight slump, has the characteristics of reduced heat conductivity coefficient, high porosity, and relatively low production cost, and could be massively applied to actual production.

The results from the examples show that the secondary-foamed foam concrete product provided by the present disclosure has a heat conductivity coefficient of 0.032-0.037 W/mK, a porosity of 72-76%, a compressive strength of 0.17-0.20 MPa, and a dry density of 133-142 kg/m³.

### BRIEF DESCRIPTION OF THE DRAWINGS

FIG. 1 shows the results of the initial coagulation time test of the secondary-foamed foam concrete provided by the present disclosure at various temperatures and humidity conditions.

FIG. 2 is a photograph of a physical object of the secondary-foamed foam concrete prepared in Example 1 of the present disclosure.

### DETAILED DESCRIPTION OF THE EMBODIMENTS

The present disclosure provides a secondary-foamed foam concrete, where raw materials for preparing the same include a main material and an additive;
the main material includes an aggregate-mineral admixture, a cement, and water; and a mass ratio of the aggregate-mineral admixture, the cement, and the water is in a range of (10-20):(40-60):(20-35);
the additive includes an emulsifier, an aqueous hydrogen peroxide solution, a biomass, and a microorganism, the biomass being an animal liver containing catalase, and the aqueous hydrogen peroxide solution having a hydrogen peroxide mass percentage concentration of 25-30%;
a mass of the emulsifier accounts for 0.5-3.5% of a mass of the main material;
a mass of the aqueous hydrogen peroxide solution accounts for 0.5-2% of the mass of the main material;
a mass of the biomass accounts for 0.4-0.7% of the mass of the main material; and
a mass of the microorganism accounts for 0.5-1% of the mass of the main material.

In the present disclosure, unless otherwise specified, all the raw materials/components used for the preparation are commercially available products well-known to those skilled in the art.

The raw materials for the preparation of the secondary-foamed foam concrete provided by the present disclosure include a main material.

In the present disclosure, the main material includes an aggregate-mineral admixture, a cement and water. In some embodiments, the cement is ordinary Portland cement 42.5. In some embodiments, the aggregate in the aggregate-mineral admixture is a fine sand. In some embodiments, a mineral admixture in the aggregate-mineral admixture includes at least one of fly ash, a limestone powder, a zeolite powder, blast furnace slag, and a steel slag powder. The aggregate and the mineral admixture in the aggregate-mineral admixture could be adjusted according to actual usage situations. In specific embodiments of the present disclosure, a mass ratio of the aggregate to the mineral admixture in the aggregate-mineral admixture is 1:1.

In some embodiments of the present disclosure, a mass ratio of the aggregate-mineral admixture, the cement, and the water is in a range of (10-20):(40-60):(20-35), preferably (12-18):(45-55):(25-30), and specifically preferably 20:50:30.

The raw materials for preparing the secondary-foamed foam concrete provided by the present disclosure include an additive.

In the present disclosure, the additive includes an emulsifier, an aqueous hydrogen peroxide solution, a biomass, and a microorganism, the biomass being an animal liver containing catalase. In specific embodiments of the present disclosure, the biomass is specifically a fresh porcine liver containing catalase. The catalase in the animal liver containing catalase is capable of decomposing hydrogen peroxide in the aqueous hydrogen peroxide solution to allow foaming. The aqueous hydrogen peroxide solution has a mass percentage content of 25-30%. In some embodiments, the emulsifier includes at least one of coconut monoethanol amide, Span 60, Span 80, Tween 60, Tween 80, and Sepigel 305, and preferably includes at least one of Span 60, Span 80, Tween 60, Tween 80, and Sepigel 305. In specific embodiments of the present disclosure, the emulsifier is Tween 80 and/or Span 80. In specific embodiments of the present disclosure, the emulsifier is Tween 80 and Span 80, the mass ratio of Tween 80 to Span 80 is preferably 5:1.

In some embodiments of the present disclosure, the microorganism includes at least one of lactobacillus, propionic acid-producing bacteria, leuconostoc, and streptococcus. In the present disclosure, the microorganism is capable of decomposing the biomass to allow foaming.

In the present disclosure, the mass of the emulsifier accounts for 0.5-3.5%, preferably 1-3%, and further preferably 1.5-2.5% of the mass of the main material. In some embodiments of the present disclosure, the emulsifier is Tween 80. In addition, by means of the addition amount of the emulsifier, the present disclosure enables the foaming system provided by the present disclosure to be maintained in a state closer to an oily system; the oily system of the present disclosure has a slow hardening speed, has plasticity, is not prone to slump because of self-weight, and has a more thorough foaming process, so that the secondary-foamed foam concrete provided by the present disclosure is not affected by cement hardening or self-weight slump, and has the characteristics of reduced heat conductivity coefficient, high porosity and relatively low production cost.

In the present disclosure, the mass of the aqueous hydrogen peroxide solution accounts for 0.5-2%, preferably 1-1.5% of the mass of the main material.

In the present disclosure, the mass of the biomass accounts for 0.4-0.7%, preferably 0.5-0.6% of the mass of the main material.

In the present disclosure, the mass of the microorganism accounts for 0.5-1%, preferably 0.6-0.8% of the mass of the main material.

The present disclosure provides a method for preparing the secondary-foamed foam concrete described in the technical solutions above, including the following steps:
(1) mixing the cement, the aggregate-mineral admixture, the water, the emulsifier, the aqueous hydrogen peroxide solution, and the biomass, and subjecting a resulting mixture to a first foaming, to obtain a primary-foamed foam concrete; and
(2) mixing the primary-foamed foam concrete and the microorganism, and subjecting a resulting system to a second foaming in a mold, to obtain the secondary-foamed foam concrete.

In the present disclosure, a cement, an aggregate-mineral admixture, water, an emulsifier, an aqueous hydrogen peroxide solution, and a biomass are mixed and a resulting mixture is subjected to a first foaming, to obtain a primary-foamed foam concrete. In some embodiments of the present disclosure, the biomass is crushed before the mixing. In some embodiments, the mixing includes the following steps: subjecting the biomass, the water, and the emulsifier to a first mixing to obtain a biomass emulsion; subjecting the aggregate-mineral admixture, the cement, and the biomass emulsion to a second mixing, to obtain a paste; and mixing the paste and the aqueous hydrogen peroxide solution for the first foaming. In some embodiments, the first mixing is performed at room temperature. In the present disclosure, there is no special requirement for the specific implementation of the first mixing. In some embodiments, the second mixing is performed at room temperature. In some embodiments, the second mixing is performed for 1 min. In some embodiments, the second mixing is performed in a stirring device. In some embodiments, the second mixing is performed under a stirring condition, preferably with a stirring rotation speed of 80 r/min. In some embodiments, the paste is a viscous cream-like paste. In some embodiments, the first foaming is performed at room temperature. In some embodiments, the first foaming is performed for 20 s to 1 min. In some embodiments, the first foaming is performed in a stirring device. In some embodiments, the first foaming is performed under a stirring condition, preferably with a stirring rotation speed of 120 r/min. The primary-foamed foam concrete is a loose, relatively viscous, pasty foamed concrete.

In the present disclosure, after the primary-foamed foam concrete is obtained, the primary-foamed foam concrete and a microorganism are mixed, and a resulting system is subjected to a second foaming in a mold to obtain the secondary-foamed foam concrete. In some embodiments of the present disclosure, the mixing the primary-foamed foam concrete and the microorganism is performed under a stirring condition, preferably at a rotation speed of 80 r/min. In some embodiments, the mixing the primary-foamed foam concrete and the microorganism is performed by stirring for 2 min.

In some embodiments of the present disclosure, the resulting system obtained by mixing the primary-foamed foam concrete and the microorganism is injected into a mold. In some embodiments, the second foaming is performed at a temperature of 15-40° C., specifically preferably at 15° C., 20° C., 25° C., 30° C., 35° C. or 40° C. In some embodiments, the environment during the foaming has a relative humidity of 50-90%, specifically preferably 50%, 70% or 90%. In some embodiments, the second foaming is performed for 6-24 h, specifically preferably 6 h or 8 h. In some embodiment, a volume of the secondary-foamed foam concrete obtained after the second foaming is increased by 20-25% compared with a volume of the primary-foamed foam concrete.

In some embodiments of the present disclosure, after the second foaming is complete, a product obtained from the second foaming is cured, and the curing is performed in the same manner as the curing of normal concrete.

To further illustrate the present disclosure, the technical solutions provided by the present disclosure will be described in detail below in conjunction with examples, however the examples could not be construed as limiting the scope of the present disclosure.

### Example 1

This example provided a secondary-foamed foam concrete, where raw materials for preparing the same was composed of a main material and an additive; the main material was composed of a fine sand, a mineral admixture, a cement, and water; the main material was composed of: in percentages by mass, 10% of the fine sand, 10% of the mineral admixture, 50% of the cement, and 30% of water. The additive was composed of an emulsifier, an aqueous hydrogen peroxide solution, a biomass, and a microorganism. The mass of the emulsifier accounted for 2.5% of the mass of the main material; the mass of the aqueous hydrogen peroxide solution accounted for 1% of the mass of the main material; the mass of the biomass accounted for 0.5% of the mass of the main material; and the mass of the biomass accounted for 0.7% of the mass of the main material. With regard to these materials: the cement was ordinary Portland cement 42.5, the aggregate in the aggregate-mineral admixture was a fine sand, the mineral admixture was fly ash, the emulsifier was Tween 80, the aqueous hydrogen peroxide solution had a mass percentage content of 30%, the biomass was a fresh porcine liver containing catalase, and the microorganism was lactobacillus.

The method for preparing the secondary-foamed foam concrete provided by this example was performed as follows:

S1. An animal liver containing catalase was crushed, water and Tween 80 were then added thereto, and the resulting mixture was mixed to obtain a biomass emulsion.

S2. An ordinary Portland cement, a fine-sand aggregate, a mineral admixture, and the biomass emulsion were added in sequence into a stirring device. The stirring device was then started, and the stirring was conducted at a rotation speed of 80 r/min for 1 min, to obtain a mixed relatively-viscous cream-like paste.

S3. Hydrogen peroxide at a mass fraction of 30% was added thereto, the rotation speed for the stirring was increased to 120 r/min, and the resulting mixture was stirred at room temperature for 1 min. After the complete decomposition of hydrogen peroxide, a loose, relatively viscous paste-like foam concrete was obtained, i.e. a primary-foamed foam concrete.

S4. A microorganism strain was added to the primary-foamed foam concrete, and the resulting mixture was stirred thoroughly and mixed at a stirring speed of 80 r/min for 2 min.

S5. The mixture obtained in step S4 was injected into a mold, and the mold was placed in a thermotank at 35° C. and 50% relative humidity, and left to stand for 6 h to allow for the bio-secondary-foaming. The foaming was terminated until the volume was increased by 25% and the mold was completely filled, to obtain the secondary-foamed foam concrete.

The secondary-foamed foam concrete product obtained in this example had a heat conductivity coefficient of 0.032 W/mK, a porosity of 76%, a compressive strength of 0.19 MPa, and a dry density of 135 kg/m³. The compressive strength was measured according to JG T2662011.

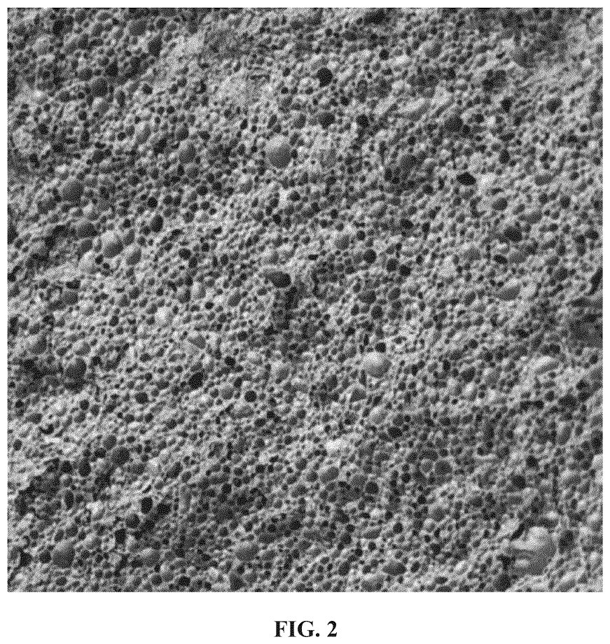

A photograph of a physical object of the secondary-foamed concrete product prepared in this example is shown in FIG. 2.

### Example 2

This example provided a secondary-foamed foam concrete, where raw materials for preparing the same was composed of a main material and an additive; the main material was composed of a fine sand, a mineral admixture, a cement, and water; the main material was composed of: in percentages by mass, 10% of the fine sand, 10% of the mineral admixture, 50% of the cement, and 30% of water; the additive was composed of an emulsifier, an aqueous hydrogen peroxide solution, a biomass, and a microorganism. The mass of the emulsifier accounted for 2.5% of the mass of the main material; the mass of the aqueous hydrogen peroxide solution accounted for 1% of the mass of the main material; the mass of the biomass accounted for 0.5% of the mass of the main material; and the mass of the biomass accounted for 0.7% of the mass of the main material. With regard to these materials: the cement was ordinary Portland cement 42.5, the aggregate in the aggregate-mineral admixture was a fine sand, the mineral admixture was fly ash, the emulsifier was Span 80, the aqueous hydrogen peroxide solution had a mass percentage content of 30%, the biomass was a fresh porcine liver containing catalase, and the microorganism was lactobacillus.

The method for preparing the secondary-foamed foam concrete provided by this example was performed as follows:

S1. An animal liver containing catalase was crushed, and normal-temperature water was added thereto, where the added water in this step accounted for 70% of the total water added for the whole preparation progress.

S2. The remaining 30% of water (i.e., hot water at a relatively high temperature of about 80° C.) was mixed with Span 80 by means of high-speed stirring, to obtain a viscous colloid containing floccules.

S3. An ordinary Portland cement, a fine-sand aggregate, a mineral admixture, a mixed solution of biomass and water, and a mixed solution of Span 80 were added in sequence into a stirring device. The stirring device was then started, and the stirring was conducted at a rotation speed of 80 r/min for 1 min, to obtain a mixed relatively-viscous cream-like paste.

S4. Hydrogen peroxide at a mass fraction of 30% was added thereto, the rotation speed for the stirring was increased to 120 r/min, and the resulting mixture was stirred at room temperature for 1 min. After the complete decomposition of hydrogen peroxide, a loose, relatively viscous paste-like foam concrete was obtained, i.e. a primary-foamed foam concrete.

S5. A microorganism strain was added to the primary-foamed foam concrete, and the resulting mixture was stirred thoroughly and mixed at a stirring speed of 80 r/min for 2 min.

S6. The mixture obtained in step S5 was injected into a mold, and the mold was placed in a thermotank at 35° C. and 50% relative humidity, and left to stand for 8 h to allow for the bio-secondary-foaming. The foaming was terminated until the volume was increased by 20% and the mold was completely filled, to obtain the secondary-foamed foam concrete.

The secondary-foamed foam concrete product obtained in this example had a heat conductivity coefficient of 0.037 W/mK, a porosity of 72%, a compressive strength of 0.19 MPa, and a dry density of 142 kg/m³. The compressive strength was measured according to JG T2662011.

### Example 3

This example provided a secondary-foamed foam concrete, where raw materials for preparing the same was composed of a main material and an additive; the main material was composed of a fine sand, a mineral admixture, a cement, and water; the main material was composed of: in percentages by mass, 5% of the fine sand, 15% of the mineral admixture, 50% of the cement, and 30% of water; the additive was composed of an emulsifier, an aqueous hydrogen peroxide solution, a biomass and a microorganism. The mass of the emulsifier accounted for 3% of the mass of the main material; the mass of the aqueous hydrogen peroxide solution accounted for 1% of the mass of the main material; the mass of the biomass accounted for 0.5% of the mass of the main material; and the mass of the biomass accounted for 0.7% of the mass of the main material. With regard to these materials: the cement was ordinary Portland cement 42.5, the aggregate in the aggregate-mineral admixture was a fine sand, the mineral admixture was fly ash, the emulsifier was a Tween 80/Span 80 mixture with a mass ratio of Tween 80 to Span 80 of 5:1, the aqueous hydrogen peroxide solution had a hydrogen peroxide mass percentage concentration of 30%, the biomass was a fresh porcine liver containing catalase, and the microorganism was lactobacillus.

The method for preparing the secondary-foamed foam concrete provided by this example was performed as follows:

S1. An animal liver containing catalase was crushed, and water was added thereto, and the resulting mixture was mixed with the Tween 80/Span 80 mixture to obtain a biomass emulsion.

S2. An ordinary Portland cement, a fine-sand aggregate, a mineral admixture, and the biomass emulsion were added in sequence into a stirring device. The stirring device was then started, and the stirring was conducted at a rotation speed of 80 r/min for 1 min, to obtain a mixed relatively-viscous cream-like paste.

S3. Hydrogen peroxide at a mass fraction of 30% was added thereto, the rotation speed for the stirring was increased to 120 r/min, and the resulting mixture was stirred at room temperature for 1 min. After the complete decomposition of hydrogen peroxide, a loose, relatively viscous paste-like foam concrete was obtained, i.e. a primary-foamed foam concrete.

S4. A microorganism strain was added to the primary-foamed foam concrete, and the resulting mixture was stirred thoroughly and mixed at a stirring speed of 80 r/min for 2 min.

S5. The mixture obtained in step S4 was injected into a mold, and the mold was placed in a thermotank at 35° C. and 50% relative humidity, and left to stand for 6 h to allow for the bio-secondary-foaming. The foaming was terminated until the volume was increased by 25% and the mold was completely filled, to obtain the secondary-foamed foam concrete.

The secondary-foamed foam concrete product obtained in this example had a heat conductivity coefficient of 0.032 W/mK, a porosity of 77%, a compressive strength of 0.17 MPa, and a dry density of 133 kg/m³. The compressive strength was measured according to JG T2662011.

### Comparative Example 1

According to Example 1 of Chinese patent publication CN112479651A (incorporated by reference), firstly, the following materials were weighed: in parts by weight, 80 parts of a Portland cement, 10 parts of a porous ceramic powder, 5 parts of a hydrogen peroxide foaming agent, and 0.3 parts of a manganese oxide foaming catalyst; 5 parts of a coagulant (i.e., a mixture of sodium carbonate and triethanolamine at a mass ratio of 10:1), and 2 parts of a foam stabilizer (i.e., calcium stearate modified by means of a nano-intercalation technique); 4 parts of a microorganism foaming agent; and 37 parts of water. The porous ceramic powder was a particle with a particle size of about 325 mesh obtained by processing an existing waste porous ceramic, where the mesh number was a common particle size of existing Portland cements; alternatively, of course, the particle size could be larger, up to a maximum of 180 mesh.

The weighed cement, porous ceramic powder, and foam stabilizer were added into a stirring vessel and the resulting mixture was subjected to dry stirring until uniform, where the purpose of the dry stirring until uniform was to thoroughly mix the cement, the porous ceramic powder, and the foam stabilizer. With regard to the selection of calcium stearate modified by means of a nano-intercalation technique as a foam stabilizer, in the process of bubble growth, the stability of the bubble is a key factor for the preparation process and performance of foamed cements. Microscopically, in porous materials, liquid film (i.e., liquid film produced by cement slurry) serves to separate bubbles, and the destruction of a bubble is equivalent to the cracking of the liquid film around the bubble. The instability of bubbles also manifests itself in the form of bubbles merging with each other and growing up. The stability of bubbles is mainly affected by surface tension and cement slurry viscosity. Changes in surface tension cause changes in bubble size, and therefore surface tension affects bubble stability. In the early stage of mixing cement slurry, the friction between the inner fluid layers is quite complex, and the obtained slurry has a relatively low plastic viscosity and a relatively fast flow rate, and bubbles are easy to merge or crack. With this regard, in this example, the cement, the porous ceramic powder, and the foam stabilizer were firstly added into a stirring vessel and were subjected to dry stirring until uniform. The dry mixing was performed at a rotation speed of 80 r/min for 30 s.

With regard to the addition of the porous ceramic powder particles, the main reason was that the particles were mostly of a sheet-like structure rather than a granular structure, and its presence could improve the smoothness of bubbles, which was mainly due to the fact that the porous ceramic powder particles did not undergo reactions, and its granular filler was used to fill voids. Moreover, the addition of the sheet-like porous ceramic powder particles provided early reinforcement for the foamed cement, whereby a good network-like framework structure was formed.

After stirring well, water was added into the stirring vessel and stirring was continued. According to the present study that the water-cement ratio at about 0.46 was optimal, and considering that the microorganism foaming agent itself contained a large amount of moisture, it was sufficient for the mixture of the microorganism foaming agent and water to reach an overall ratio of 0.46. The wet mixing was conducted at a rotation speed of 80 r/min for 2 min.

The manganese oxide foaming catalyst was then rapidly added to hydrogen peroxide, and after rapid stirring, the resultant mixture was rapidly added into the stirring vessel, and the stirring was continued with a stirring speed of 1000 r/min. In this example, the main purpose of adding the catalyst was to make hydrogen peroxide react quickly, and similarly, the stirring speed was also for the same purpose, such that hydrogen peroxide was reacted completely within 10-20 s. The main purpose of this setting was that the microorganism catalyst could only be added after hydrogen peroxide had been reacted quickly and completely because hydrogen peroxide a strong biocidal effect due to its strong oxidizing properties. Furthermore, a high stirring speed also helped to break up the bubbles formed from hydrogen peroxide, and further prevented the rising of bubbles, which resulted in no bubbles at the bottom of the mold and more bubbles at the top, thereby ensuring an even distribution of bubbles. Another reason is that the slurry would coagulate and become hardened during the preparation of the foamed cement. In this regard, accelerating its reaction speed and stirring speed could allow a better action of the microorganism foaming agent. In this example, manganese oxide and hydrogen peroxide were added, and the stirring was conducted at a rotation speed of 1000 r/min for 1 min.

A pipette was used to take 4 parts (4 mL) of distilled water, and 40 mg of glucose, trypsin and 20 mg of yeast extract powder were added. The resulting mixture were stirred until uniform and then portioned into conical flasks and sterilized in a high-pressure steam sterilization pot. The resulting mixture was taken out after the sterilization was completed and placed on a sterile operating table, cooled and then inoculated with a 10% (0.4 ml of distilled water+0.4 mg of dry yeast) yeast mother liquor to obtain a yeast solution. The yeast solution was placed in a constant-temperature oscillation incubator with a rotation speed of 170 r/min and a temperature of 30° C. and subjected to oscillation culture for 48 h to obtain a microorganism foaming agent. The microorganism foaming agent and the coagulant were added into the stirring vessel.

The stirring was performed at 80 r/min for 1 min. The total wet-mixing stirring time was 4 min. After the stirring, the slurry was injected into a mold, and subjected to curing and molding until the slurry was cured and molded.

After the curing, the dry density of the test block was measured, and the measured density was 310 kg/m³, which was much greater than 159.7 kg/m³. It was failed to obtain the results of Example 1 of Chinese patent publication CN112479651A.

### Test Example

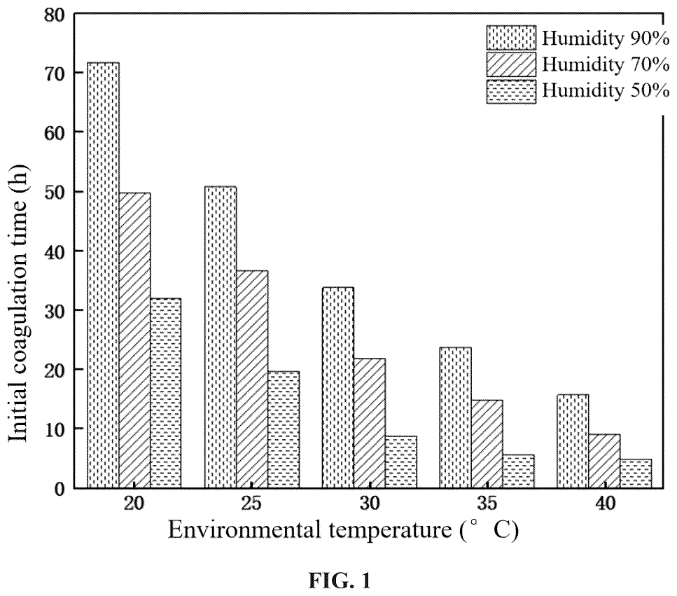

The raw materials were weighed according to the content of each raw material in Example 1, and the steps S1-S5 in Example 1 were repeated, wherein after the first foaming, second-foaming experiments were performed at environmental temperatures of 20° C., 25° C., 30° C., 35° C. and 40° C., and environmental humidities of 90%, 70%, and 50%, respectively. The results are shown in FIG. 1.

The groups where the final coagulation time and the initial coagulation time exceeded 10 h were excluded. At 35° C. and 50% relative humidity, the initial coagulation time was 6 h and the final coagulation time was 8 h, which was recorded as sample A; after the final coagulation, sample A was cured and then tested to give a compressive strength of 0.20 MPa, a heat conductivity coefficient of 0.034 W/mK, and a dry density of 138 kg/m³. At 40° C. and 70% relative humidity, the initial coagulation time was 9 h and the final coagulation time was 10 h, which was recorded as sample B, and the sample B was cured and then tested to give a compressive strength of 0.19 MPa, a heat conductivity coefficient of 0.032 W/mK, and a dry density of 135 kg/m³. At 40° C. and 50% relative humidity, the initial coagulation time was 5 h and the final coagulation time was 6 h, which was recorded as sample C, and the sample C was cured and then tested to give a compressive strength of 0.20 MPa, a heat conductivity coefficient of 0.034 W/mK, and a dry density of 140 kg/m³. It shows that the secondary-foamed foam concrete provided by the present disclosure also has the effect of a relatively long initial coagulation time at high temperatures and in relatively dry conditions.

### Test Example 2

Example 1 in Chinese patent publication CN112479651A was repeated: In the step of adding the microorganism foaming agent and the coagulant into the stirring vessel, mixing, and then continuing to mix, the slurry did not change significantly in volume, including the fact that the slurry volume was almost unchanged after the slurry was poured into the mold. It thus could be judged that the method in Example 1 of the Chinese patent publication CN112479651A is performed by pre-preparing a bio-foam and then mixing it with a foam produced by chemical foaming by stirring. Since a coagulant was added, the concrete prepared by the Chinese patent publication CN112479651A had an initial coagulation time of about 40-60 min, which was a relatively short initial coagulation time. In addition, in the case similar with Example 1 of the Chinese patent publication CN112479651A except that no coagulant was added, the slurry in the mold slumped within 5 min due to self-weight.

In contrast, in step S5 in the present disclosure, the slurry was injected into the mold without fully filling the mold, and there was a relatively long foaming process before the hardening and initial coagulation of the concrete. Moreover, due to its inherent plasticity, the concrete did not self-slump, even with a relatively long initial coagulation time.

It is known from the above examples that: the advantages of the present disclosure over the conventional art are that: the secondary-foamed foam concrete of the present disclosure has a lower heat conductivity coefficient, a high porosity, and a lower production cost compared with conventional foam concretes, and could be massively applied to actual production to reduce engineering costs. In addition, as compared with traditional biological and chemical methods, the bio-foaming process is more thorough and is not affected by cement hardening or self-weight slump.

Although the examples described above have provided a detailed description of the present disclosure, they are only a part of, rather than all of the examples of the present disclosure. All other examples that could be obtained according to the examples of the present disclosure without creative efforts shall fall within the scope of the disclosure.

What is claimed is:

1. A secondary-foamed foam concrete, comprising:
a main material comprising an aggregate-mineral admixture, a cement, and water, a mass ratio of the aggregate-mineral admixture, the cement, and the water being in a range of (10-20):(40-60):(20-35); and
an additive comprising an emulsifier, an aqueous hydrogen peroxide solution, a biomass, and a microorganism, the biomass being an animal liver containing catalase, and the aqueous hydrogen peroxide solution having a hydrogen peroxide mass percentage concentration of 25-30%; wherein
a mass of the emulsifier accounts for 0.5-3.5% of a mass of the main material;
a mass of the aqueous hydrogen peroxide solution accounts for 0.5-2% of the mass of the main material;
a mass of the biomass accounts for 0.4-0.7% of the mass of the main material; and
a mass of the microorganism accounts for 0.5-1% of the mass of the main material.

2. The secondary-foamed foam concrete as claimed in claim 1, wherein the microorganism comprises at least one selected from the group consisting of lactobacillus, propionic acid-producing bacteria, leuconostoc, and streptococcus.

3. The secondary-foamed foam concrete as claimed in claim 1, wherein the emulsifier comprises at least one selected from the group consisting of coconut monoethanol amide, sorbitan monostearate, sorbitan monooleate, polyoxyethylene sorbitan monostearate, and polyoxyethylene sorbitan monooleate.

4. The secondary-foamed foam concrete as claimed in claim 1, wherein the cement is ordinary Portland cement.

5. The secondary-foamed foam concrete as claimed in claim 1, wherein the aggregate in the aggregate-mineral admixture is a sand, and a mineral admixture in the aggregate-mineral admixture comprises at least one selected from the group consisting of fly ash, a limestone powder, a zeolite powder, blast furnace slag, and a steel slag powder.

6. A method for preparing the secondary-foamed foam concrete as claimed in claim 1, comprising:
(A) mixing the cement, the aggregate-mineral admixture, the water, the emulsifier, the aqueous hydrogen peroxide solution, and the biomass, and subjecting a resulting mixture to a first foaming, to obtain a primary-foamed foam concrete; and
(B) mixing the primary-foamed foam concrete and a microorganism, and subjecting a resulting system to a second foaming in a mold, to obtain the secondary-foamed foam concrete.

7. The method as claimed in claim 6, wherein the first foaming is performed at room temperature for 20 s to 1 min, and the first foaming is performed under a stirring condition with a stirring rotation speed of 120 r/min.

8. The method as claimed in claim 6, wherein the second foaming is performed at room temperature for 6-24 h.

9. The method as claimed in claim 6, wherein in step (A), the mixing comprises:
subjecting the biomass, the water, and the emulsifier to a first mixing, to obtain a biomass emulsion;
subjecting the aggregate-mineral admixture, the cement, and the biomass emulsion to a second mixing, to obtain a paste; and
mixing the paste and the aqueous hydrogen peroxide solution for the first foaming.

10. The method as claimed in claim 7, wherein in step (A), the mixing comprises:
subjecting the biomass, the water, and the emulsifier to a first mixing, to obtain a biomass emulsion;
subjecting the aggregate-mineral admixture, the cement, and the biomass emulsion to a second mixing, to obtain a paste; and
mixing the paste and the aqueous hydrogen peroxide solution for the first foaming.

11. The method as claimed in claim 9, wherein the second mixing is performed at room temperature for 1 min, and the second mixing is performed by stirring at a rotation speed of 80 r/min.

12. The method as claimed in claim 6, wherein the microorganism comprises at least one selected from the group consisting of lactobacillus, propionic acid-producing bacteria, leuconostoc, and streptococcus.

13. The method as claimed in claim 6, wherein the emulsifier comprises at least one selected from the group consisting of coconut monoethanol amide, sorbitan monostearate, sorbitan monooleate, polyoxyethylene sorbitan monostearate, and polyoxyethylene sorbitan monooleate.

14. The method as claimed in claim 6, wherein the cement is ordinary Portland cement.

15. The method as claimed in claim 6, wherein the aggregate in the aggregate-mineral admixture is a sand; and a mineral admixture in the aggregate-mineral admixture comprises at least one selected from the group consisting of fly ash, a limestone powder, a zeolite powder, blast furnace slag, and a steel slag powder.
